(19) United States
(12) Patent Application Publication
(10) Pub. No.: US 2007/0272050 A1
(43) Pub. Date: Nov. 29, 2007

(54) MULTI-PIECE FOOTPEG

(76) Inventor: Robert L. Barnett, Santa Ana, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/750,915

(22) Filed: May 18, 2007

Related U.S. Application Data
(60) Provisional application No. 60/801,773, filed on May 19, 2006.

(51) Int. Cl. G05G 1/18

(52) U.S. Cl. 74/564

(57) ABSTRACT

A vehicle footpeg comprising a base that is connectable to a vehicle and a foot support that is connectable to the base. The foot support is preferably attached to the base by removable fasteners permitting the user to easily remove and replace the foot support without having to remove or replace the base. A variety of interchangeable foot supports that have different heights and different surface configurations can be manufactured to accommodate different vehicle rider heights and different applications of the footpeg.

### RELATED APPLICATIONS

This application is related to, and claims the benefit of, U.S. Provisional Patent Application No. 60/801,773, filed May 19, 2006, the entirety of which is hereby incorporated by reference herein and made a part of the present disclosure.

### BACKGROUND OF THE INVENTION

1. Field of the Invention

The present invention relates to an improved footpeg for straddle-type vehicles, such as motorcycles, for example.

2. Description of the Related Art

Straddle-type vehicles, such as motorcycles, ATV's and the like, often employ a pair of footpegs placed on opposing sides of the vehicle for a rider of the vehicle to place his or her feet. In some cases, the foot pegs may include a serrated upper surface to provide better “grip” for the rider. That is, the teeth of the serrated surface of the footpeg tend to dig into the sole of the footwear, such as a boot, worn by the rider. Accordingly, it is easier for the rider to maintain his or her feet on the footpegs despite the forces acting on the rider due to accelerations of the vehicle or traversing bumps or other obstacles, for example.

One type of vehicle footpeg includes a plurality of set screws coupled to, and extending in an upward direction from, the upper surface of a base portion of the footpeg. In such an arrangement, the set screws perform the function of the teeth, or serrations, described above. In addition, the set screws may be replaced when worn.

### SUMMARY OF THE INVENTION

One aspect of the present invention is the realization that the height adjustment and/or replacement of the set screws in the above-described embodiment is time consuming and tedious. In addition, only a limited number of set screws may be placed on the upper surface of the footpeg base due to space restraints. Furthermore, set screws may loosen and become separated from the footpeg due to vibrations or other forces acting on the set screws. Thus, there exists a need for an improved footpeg design.

Another aspect of the present invention addresses the realization that providing a design that can be manufactured by commonly known casting or molding techniques would lower the production costs. However, because there is a wide range of vehicles that the present footpeg is designed to mount to, each vehicle potentially having different mounting interface requirements, there is great difficulty in designing a mass producible molded footpeg without incurring the significant cost of building many casting patterns specific to each vehicle's mounting interface requirements. Thus, there exists a need for an improved moldable footpeg design.

One non-limiting embodiment of the footpeg of the present invention includes a base that is connectable to a vehicle, such as a motorcycle, for example. A foot support is connectable to the base and, when so connected, defines a foot support surface of the footpeg. Generally, the foot support surface faces in a generally upwardly direction (when the footpeg is mounted to a straddle-type vehicle, such as a motorcycle, for example). In other applications, however, the foot support surface may face in a direction other than upward, such as when used in connection with a go-kart or other similar vehicle, for example. The foot support may include a plurality of teeth, or other forms of serrations, to improve grip. The foot support preferably is available in various heights, so that an individual rider may choose an appropriate height of the foot support according to the rider's physical characteristics (e.g., height) or structural characteristics of the vehicle.

Another non-limiting embodiment of the footpeg of the present invention includes a footpeg base that is connectable to a vehicle, and a foot support connectable to the base that, when so connected, defines a foot support surface of the footpeg. Generally, the base, as well as the mounting features of the base that interface with the mounting features of the foot support, face in a generally upwardly direction such that the main portion of the base can be easily formed in a two piece mold without requiring significant subsequent machining or other processing. Further, the flange that connects the footpeg base to the vehicle will have a vehicle specific design depending on the vehicle's interface requirements. Accordingly, the flange of this embodiment of the footpeg is preferably formed in a third mold portion having a vehicle specific design and that is connectable to the previously described two mold portions such that the entire footpeg base (or a pattern for the footpeg base) is simultaneously formed in the mold cavity defined by the three mold portions, each of which is interchangeable.

### BRIEF DESCRIPTION OF THE DRAWINGS

The above-mentioned and other features of the inventions disclosed herein are described below with reference to the figures of preferred embodiments. The figures of preferred embodiments are intended to illustrate and not to limit the present invention. The drawings contain 9 figures.

FIG. 1 is an exploded top plan view of an embodiment of the footpeg base and foot support of the present invention.

FIG. 2 is an exploded side view of the embodiment of the footpeg base and foot support illustrated in FIG. 1. A fastener, such as a screw, is illustrated as one example of how the foot support may be connected to the footpeg base.

FIGS. 3a-3c are side views of embodiments of foot supports of the present invention having various height dimensions.

FIG. 4 is a top view of another embodiment of the footpeg base of the present invention.

FIG. 5 is an enlarged section view of the embodiment of the footpeg base illustrated in FIG. 4 taken along line 5-5 in FIG. 4.

FIG. 6 is an enlarged section view of the embodiment of the footpeg base illustrated in FIG. 4 taken along line 6-6 in FIG. 4.

FIG. 7 is a sectional view of an embodiment of an assembled footpeg of the present invention at the same section of the footpeg base as illustrated in FIG. 6.

FIG. 8 is a side view of the embodiment of the foot support of the present invention illustrated in FIG. 4.

FIG. 9 is a sectional view of a mold for manufacturing the footpeg of the present invention.

### DETAILED DESCRIPTION OF THE PREFERRED EMBODIMENTS

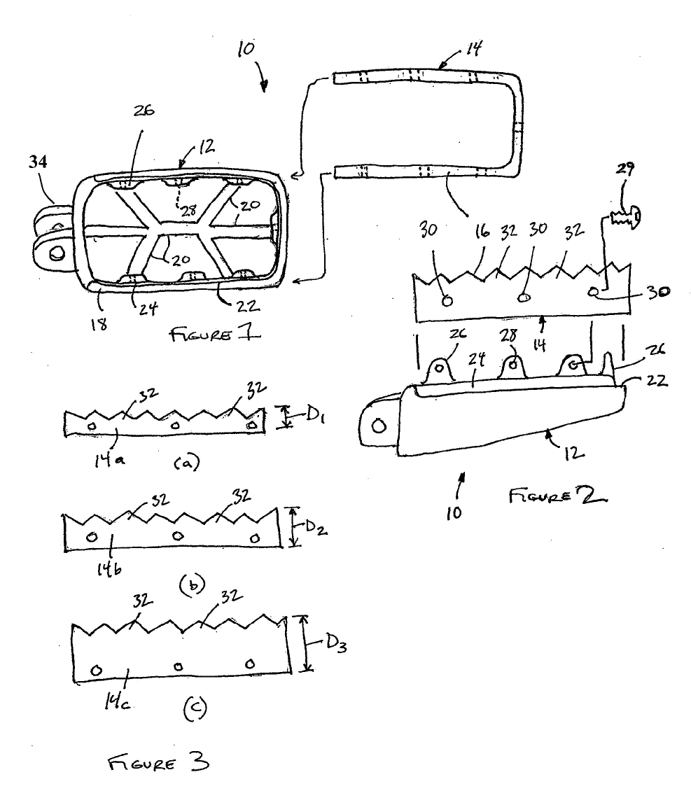

FIGS. 1 and 2 illustrate an embodiment of the footpeg 10 having certain features, aspects and advantages of the present invention. The arrows in FIG. 1 illustrate that the foot support may be positioned on the footpeg base. The illustrated footpeg 10 includes a footpeg base 12 and a foot support 14. The footpeg base 12 is configured to be connectable to a vehicle by any conventional or suitable connecting structure or method. The foot support 14 is configured to be supported by the footpeg base 12 and, preferably, the foot support 14 is removably connectable to the footpeg base 12. The foot support 14 defines a foot support surface 16 configured to permit a rider of an associated vehicle (not shown) to place his or her feet on the foot support surface 16.

The embodiment of the footpeg base 12 illustrated in FIGS. 1 and 2 is generally rectangular in shape in top plan view and includes an outer perimeter portion 18 and internal struts 20 that reinforce the outer perimeter portion. Such a structure provides strength, but is also lightweight. Furthermore, the open spaces between the struts 20 permit dirt, mud, and other debris to pass through the footpeg 10. The perimeter and struts may be monolithically formed or may be constructed as an assembly of individual components. In addition, other suitable shapes and constructions of the footpeg base 12 may be employed. The embodiment of the footpeg base 12 illustrated in FIGS. 1 and 2 includes a mount portion (e.g., a mounting boss or a pair of flanges 34) which permit the footpeg base 12 to be connected to a vehicle. Other suitable arrangements may also be used.

The footpeg 10, including the footpeg base 12 and/or the foot support 14 may be formed from a metal alloy including steel or aluminum, from a composite material, or from any suitable material that provides the desired strength and rigidity. A benefit of the arrangement of the footpeg 10 illustrated in FIG. 1 is that the footpeg base 12 and the foot support 14 may be interchangeable, permitting the user to select differing materials for the footpeg base 12 as compared to the foot support 14 depending on the desired strength, weight, and/or rigidity of the component. The footpeg base 12 and/or the foot support 14 may be formed by metal injection molding, metal casting, machining, rolling, pressing, or any other suitable forming process or combination thereof.

The footpeg base 12 preferably also defines a generally planar base surface or support surface 22 configured to receive and support the foot support 14. The support surface 22 may contact all or a portion of a corresponding surface of the foot support 14. In the illustrated arrangement, the support surface 22 is a shelf-like structure which extends partially or entirely around the perimeter of the footpeg base 12. If desired, the support surface 22 may be disposed both at the perimeter of the footpeg base 12, as well as within an interior portion of the footpeg base 12. Furthermore, in some embodiments, the support surface 22 may be entirely within a perimeter of the footpeg base 12.

The footpeg base 12 may include an upwardly-extending wall 24 that is generally perpendicular to the support surface 22. In the illustrated arrangement, the support surface 22 and the wall 24 cooperate to contact a bottom surface and an interior side surface, respectively, of the foot support 14. If desired, however, an intermediate member may be positioned between the foot support 14 and the footpeg base 12, such as a shock absorbing or vibration damping member, for example. If such a member is included, the foot support 14 may be mounted to the footpeg base 12 in a manner to permit some relative motion therebetween, as will be appreciated by one of skill in the art.

The illustrated footpeg base 12 also includes at least one, and preferably a plurality of mounting tabs or bosses 26, each of which defines an opening 28 configured to accommodate a fastener. In the illustrated arrangement, the fastener is a threaded fastener 29, such as a bolt or screw. However, any suitable fastening means may be used to fasten the foot support 14 to the footpeg base 12. The opening 28 may be threaded to cooperate with the threaded fastener 29. In other arrangements, other types of fasteners may be used. For example, rivets may be used in one embodiment. However, in some embodiments, fasteners that are more easily removable than rivets may be desirable to permit easy replacement of the foot support 14. In the illustrated arrangement, seven bosses 26 are provided, with three on each of the forward and rearward sides of the footpeg base 12 and one on an outboard side of the footpeg base 12. However, other numbers and placements of bosses 26 may also be used.

The illustrated foot support 14 is substantially U-shaped in top plan view. The open end of the U-shape is configured to correspond with an inboard end of the footpeg base 12, or the end adjacent to the vehicle. However, in other arrangements, the foot support 14 may define a fully closed perimeter and may be generally rectangular, oval in shape, or any other suitable shape. In addition, although the illustrated embodiment is configured to cooperate with a peripheral portion of the footpeg base 12, in other arrangements, the foot support 14 may also include an interior portion which cooperates with an interior portion of the footpeg base 12, such as the struts 20, for example.

The foot support 14 preferably includes openings 30 in a side wall of the body of the foot support 14. The openings 30 are configured to cooperate with the openings 28 of the bosses 26 of the footpeg base 12. In particular, one or more of the openings 28 are in registration with an associated one of the openings 30 when the foot support 14 is positioned on the footpeg base 12. Preferably, one opening 30 is provided for each opening 28 of the bosses 26.

Preferably, the foot support surface 16 of the foot support 14 includes a plurality of teeth 32 such that the foot support surface 16 defines a serrated shape to improve grip. The teeth 32 may be generally triangular in shape, or may be other suitable shapes or sizes to provide a desired amount of grip. In some embodiments, the foot support surface 16 may be generally smooth and/or may be provided with a friction and/or cushioning material, such as a rubber or rubber-type coating, for example.

With reference to FIGS. 3a-3c, preferably, foot supports 14 having varying heights are sold with the footpeg 10 as a kit, or are optionally available with the footpeg 10. In addition, as a pair of footpegs 10 is generally used in connection with a straddle-type vehicle, preferably a pair of footpegs 10 is sold as a kit. The varying heights of foot supports 14 permit a user to select a suitably-sized foot support 14 according to his or her height, leg length, personal preference or vehicle characteristics or dimensions. In addition, a user may select different foot support 14 heights on each of the pair of footpegs 10 to, for example, accommodate a leg length discrepancy or non-symmetrical vehicle dimensions between the right and left sides. If desired, footpegs 10 including a pair of footpeg bases 12 and at least a pair of foot supports 14 of a desired height, including different heights between the pair of foot supports 14, may be sold as a kit. In addition to several standard height options, custom height foot supports 14 may also be made available.

In FIG. 3a, a first foot support 14a defines a first height dimension D1. FIG. 3b illustrates a second foot support 14b defining a second height dimension D2 greater than the first height dimension D1. FIG. 3c illustrates a third foot support 14c defining a third height dimension D3 greater than both the first and second height dimensions D1 and D2. The heights D1, D2 and D3 may be of any suitable relative actual height dimensions and may represent standard sizing options of the footpegs 10. A greater or lesser number of foot support height options may also be provided.

FIG. 4 illustrates another embodiment of the footpeg 50 having certain features, aspects and advantages of the present invention. The illustrated footpeg 50 includes a footpeg base 52 and a foot support 54. The footpeg base 52 is configured to be connectable to a vehicle by any conventional or suitable connecting structure or method. The foot support 54 is configured to be supported by the footpeg base 52 and, preferably, the foot support 54 is removably connectable to the footpeg base 52. The foot support 54 defines a foot support surface 56 configured to permit a rider of an associated vehicle (not shown) to place his or her feet on the foot support surface 56.

The embodiment of the footpeg base 52 illustrated in FIG. 4 is generally rectangular in shape in top plan view and includes an outer perimeter portion 58 and internal struts 60 that reinforce the outer perimeter portion. Such a structure provides strength, but is also lightweight. Furthermore, the open spaces between the struts 60 permit dirt, mud, and other debris to pass through the footpeg 50. The perimeter and struts may be monolithically formed or may be constructed as an assembly of individual components. In addition, other suitable shapes and constructions of the footpeg base 52 may be employed. The embodiment of the footpeg base 52 illustrated in FIG. 4 includes a mount portion (e.g., a mounting boss or a pair of flanges 74) which permit the footpeg base 52 to be connected to a vehicle. Other suitable arrangements may also be used.

The footpeg base 52 preferably also defines a support surface 62 configured to receive and support the foot support 54. The support surface 62 may contact all or a portion of a corresponding surface of the foot support 54. In the illustrated arrangement, the support surface 62 is a channel-like structure which extends partially or entirely around the perimeter of the footpeg base 52. If desired, the support surface 62 may be disposed both at the perimeter of the footpeg base 52, as well as within an interior portion of the footpeg base 52. Furthermore, in some embodiments, the support surface 62 may be entirely within a perimeter of the footpeg base 52.

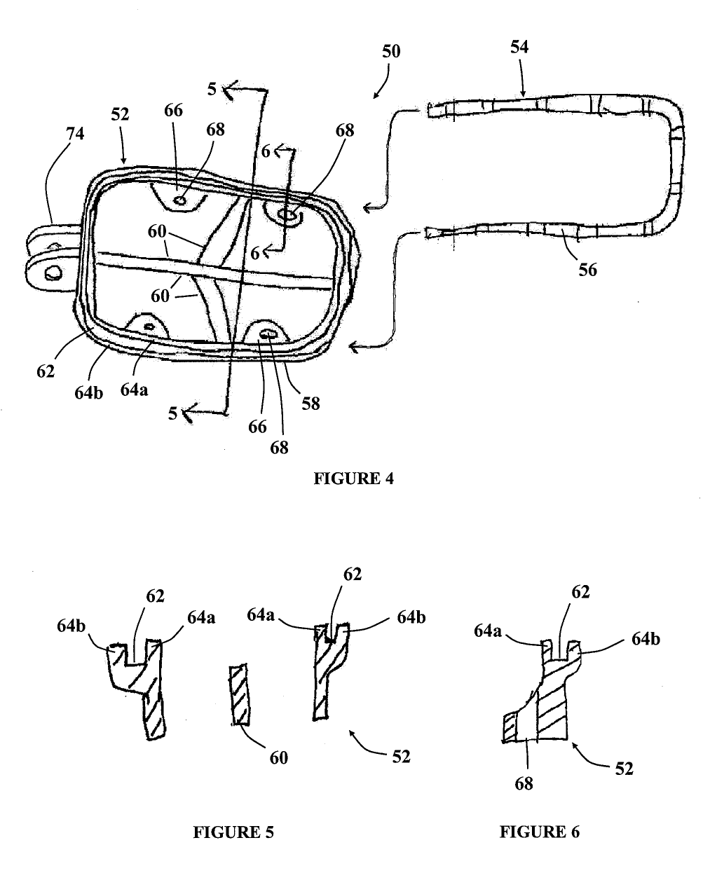

As illustrated, especially in FIGS. 5 and 6, the footpeg base 52 may include one or more upwardly-extending walls 64 that are generally perpendicular to the support surface 62. In the illustrated arrangement, the footpeg base 52 has two upwardly-extending walls 64a, 64b that are generally perpendicular to the support surface 62 and parallel to one another. The support surface 62 may be defined as the area between the upwardly-extending walls 64a, 64b. The support surface 62 and the walls 64a, 64b preferably cooperate to contact a bottom surface, an interior side surface, and an exterior side surface, respectively, of the foot support 54. However, in other arrangements, the foot support 54 may contact less than all of the support surface 62 and walls 64a, 64b. For example, any suitable portion of one or more of the support surface 62 and walls 64a, 64b may be configured to contact and/or locate the foot support 54 relative to the footpeg base 52.

The illustrated footpeg base 52 also includes at least one tab 66, but preferably a plurality of tabs 66, each of which defines an opening 68 configured to accommodate a fastener, such as a bolt or screw. In the illustrated arrangement, four tabs 66 are provided, with two on each of the forward and rearward sides of the footpeg base 52. However, other numbers and placements of tabs 66 may also be used. The foot support 54 preferably includes openings 72 in a side wall of the body of the foot support 54. The openings 72 are configured to cooperate with the openings 68 defined in the tabs 66 of the footpeg base 52 as described above. Preferably, one opening 72 is provided for each opening 68 located in the tabs 66 of the footpeg base 52. The opening 68 preferably is unthreaded but, optionally, may be threaded to cooperate with a threaded fastener.

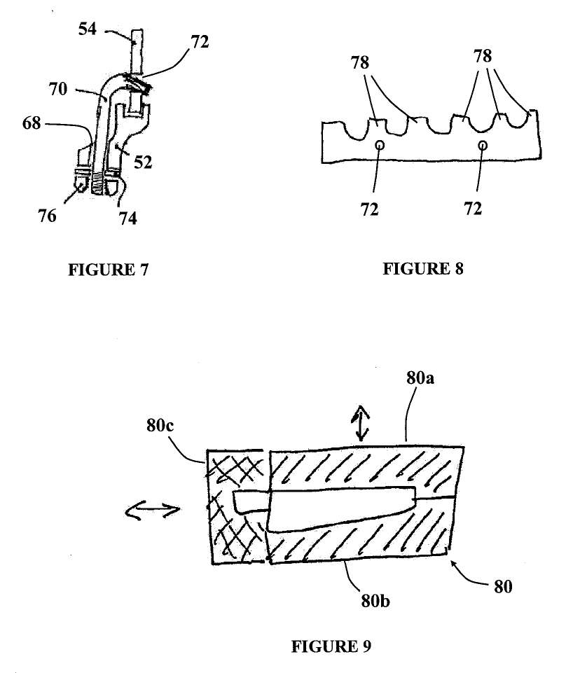

In the arrangement illustrated in FIG. 7, a non-linear or “J” shaped threaded fastener 70 is used to mount the foot support 54 to the footpeg base 52. As illustrated in FIG. 7, the upper portion of the “J” shaped threaded fastener 70, which optionally may be threaded, is passed through opening 72 of the foot support 54, while the lower, threaded portion of the “J” shaped threaded fastener 70 is passed through the unthreaded opening 68 in the footpeg base 52. A suitable retention arrangement, such as a washer 74 and locking nut 76, for example, may be used to secure the “J” shaped threaded fastener 70 to the footpeg base 52. In the illustrated arrangement, the opening 68 is preferably unthreaded to permit the “J” shaped threaded fastener 70 to pass axially through the opening 68 in the footpeg base 52 without rotation so that the “J” shaped threaded fastener 70 can also be inserted into the opening 72 in the foot support 54.

However, any suitable fastening means may be used to fasten the foot support 54 to the footpeg base 52. For example, the foot support 54 can also have struts (not illustrated) similar to the struts 60 of the footpeg base 52, wherein the struts on the foot support 54 have one or more openings that are aligned with one or more openings defined in the struts 60 or tabs 66 in the footpeg base 52. In this configuration, the foot support 54 could be removably fastened to the footpeg base 52 by bolting the footpeg base 52 and the foot support 54 together by inserting one or more bolts through the aligned openings. However, any suitable fastening means may be used to fasten the foot support 54 to the footpeg base 52. In other arrangements, other types of fasteners such as screws, rivets, adhesives, or other suitable components or materials may be used.

The illustrated foot support 54 is substantially U-shaped in top plan view. The open end of the U-shape is configured to correspond with an inboard end of the footpeg base 52, i.e., the end adjacent to the vehicle. However, in other arrangements, the foot support 54 may define a fully closed perimeter and may be generally rectangular, oval in shape, or any other desirable shape. In addition, although the illustrated embodiment is configured to cooperate with a peripheral portion of the footpeg base 52, in other arrangements, the foot support 54 may also include an interior portion which cooperates with an interior portion of the footpeg base 52, such as the struts 60.

Preferably, the foot support surface 56 of the foot support 54 includes a plurality of protrusions 78 such that the foot support surface 56 defines a serrated surface to improve grip. Desirably, the plurality of protrusions 78 are integrally formed in the foot support 54. The protrusions 78 may be generally conical, triangular, or rectangular in shape, or may be other suitable shapes or sizes to provide a desired amount of grip. In some embodiments, the foot support surface 56 may be generally smooth and/or may be provided with a friction and/or cushioning material, such as a rubber or rubber-type coating, for example.

As with the embodiment of the foot support 14 illustrated in FIG. 3, foot supports 54 having varying heights are preferably sold with the footpeg 50 as a kit, or are optionally available with the footpeg 50. In addition, as a pair of footpegs 50 is generally used in connection with a straddle-type vehicle, preferably a pair of footpegs 50 is sold as a kit. The varying heights of foot supports 54 permit a user to select a suitably-sized foot support 54 according to his or her height, leg length, personal preference or vehicle characteristics or dimensions. In addition, a user may select different foot support 54 heights on each of the pair of footpegs 50 to, for example, accommodate a leg length discrepancy or non-symmetrical vehicle dimensions between the right and left sides. If desired, footpegs 50 including a pair of footpeg bases 52 and at least a pair of foot supports 54 of a desired height, including different heights between the pair of foot supports 54, may be sold as a kit. In addition to several standard height options, custom height foot supports 54 may also be made available.

The footpeg 50 arrangement described herein advantageously permits relatively quick and simple adjustment of a height of the footpeg 50, or provides the ability to simply and relatively quickly replace the foot supports 54 to provide a new foot support surface 56, for example in the event that the protrusions 78 become worn.

The footpeg 50, including the footpeg base 52 and/or the foot support 54, may be formed from a metal alloy including steel or aluminum, from a composite material, or from any suitable material that provides the desired strength and rigidity. A benefit of the arrangement of the footpeg 50 illustrated in FIG. 4 is that the footpeg base 52 and the foot support 54 may be interchangeable, permitting the user to select differing materials for the footpeg base 52 as compared to the foot support 54 depending on the desired strength, weight, and/or rigidity of the component. The footpeg base 52 and/or the foot support 54 may be formed by metal injection molding, metal casting, machining, rolling, pressing, and/or any other suitable forming process or combination thereof.

Another readily recognizable benefit of the arrangement of the footpeg 50 illustrated in FIG. 4 is that the footpeg base 52, or a form or pattern for creating the footpeg base 52, is configured to be easily formed in a mold. This is because the struts 60, upwardly-extending walls 64a, 64b, tabs 66, openings 68 and other features are configured and oriented such that they can be formed in a two-piece casting mold with little or no subsequent machining or other forming operations. For example, preferably, the footpeg base 52 is formed by an investment casting or “lost wax” process in which a wax form or pattern is created by injecting molten wax into a mold. As is known, the wax form is used to create a sand or ceramic-based mold in the desired shape of the footpeg base 52. The wax is removed from the sand mold and a molten metal is poured into the mold to form the footpeg base 52. However, these advantages of the footpeg base 52 also apply to other manufacturing options that utilize a mold.

The embodiment of the mold 80 illustrated in FIG. 9 is suitable for forming the footpeg base 52. The mold 80 has an upper mold portion 80a, a lower mold portion 80b, and a lateral mold portion 80c. The lateral mold portion 80c is preferably used to form the mount portion or flange 74 that is used to mount the footpeg to the vehicle. The upper and lower mold portions 80a, 80b are preferable used to form the reminder of the footpeg base. The vertical arrows illustrated in FIG. 9 indicate that the upper mold portion 80a and lower mold portion 80b can be separated by moving the upper mold portion 80a and/or lower mold portion 80b in opposite vertical directions. The horizontal arrows shown in FIG. 9 indicate that the lateral mold portion 80c can be separated from the upper and lower mold portions 80a, 80b by moving the lateral mold portion 80c and/or upper and lower mold portions 80a, 80b in opposite horizontal directions. It is noted that the directional descriptions used herein refer to the footpeg 10 and/or mold 80 in the orientation shown in the figures and is not intended to be limiting.

The mold portions 80a, 80b, or 80c are preferably interchangeable such that a wide range of footpeg base configurations can be manufactured by interchanging differently configured mold portions 80a, 80b, or 80c. For example, a manufacturer may have just one set of upper and lower mold portions 80a, 80b, but a plurality of lateral mold portions 80c, each of which is configured to be interchangeable with the of upper and lower mold portions 80a, 80b, to accommodate differing flange 74 designs. This enables the portion of the footpeg 50 that is formed in the set of upper and lower mold portions 80a, 80b to be attached to a wide range of different vehicles. By adding additional sets of upper and lower mold portions 80a, 80b that are also interchangeable with each of the plurality of lateral mold portions 80c, the manufacturer can easily produce a very wide range of differently configured footpegs to fit any desired vehicle.

Foot support 56 is may be formed by stamping a bar or sheet of steel, aluminum, or other suitable alloy plate and bending the stamped plate into the desired shape. The openings 70 are preferably formed as part of the stamping operation, but can also be formed during a subsequent machining operation. In addition, other suitable methods for creating the foot support 56 may also be used.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present footpeg has been described in the context of particularly preferred embodiments, the skilled artisan will appreciate, in view of the present disclosure, that certain advantages, features and aspects of the system may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention.

What is claimed is:

1. A vehicle footpeg, comprising:
a base portion that is attachable to a vehicle; and
a foot support portion removably attached to said base portion, said foot support portion defining a serrated foot support surface to support said foot of a rider of said vehicle.

2. The footpeg of claim 1, wherein said base portion defines a generally planar base surface that supports a bottom surface of said foot support portion.

3. The footpeg of claim 2, wherein said base portion defines one or more mounting tabs for fastening said foot support portion to said base portion.

4. The footpeg of claim 3, wherein each of said one or more mounting tabs defines one or more holes therethrough in a direction perpendicular to said base surface.

5. The footpeg of claim 2, wherein said base portion defines a perimeter and a first wall protruding perpendicularly from said base surface and offset to said inside of said perimeter of said base portion such that at least a portion of an outside side surface of said first wall contacts an inside side surface of said foot support portion.

6. The footpeg of claim 5, wherein:
said base portion further defines a second wall protruding perpendicularly from said base surface;
said second wall has an inside side surface that is substantially parallel to said outside side surface of said first wall;
wherein at least a portion of said inside side surface of said second wall contacts an outside side surface of said foot support portion.

7. The footpeg of claim 1, wherein said base portion defines a perimeter that is generally rectangular shaped.

8. The footpeg of claim 1, wherein said base portion defines a perimeter that is generally ovular shaped.

9. The footpeg of claim 1, wherein said foot support portion defines a perimeter that is generally “U” shaped in top plan view.

10. The footpeg of claim 1, wherein said base portion defines one or more struts.

11. The footpeg of claim 1, further comprising a means for removably fastening said foot support portion to said base portion.

12. The footpeg of claim 1, wherein said base portion defines a mount portion for attachment of said footpeg to a vehicle.

13. The footpeg of claim 1, wherein said protrusions define a generally triangular geometry.

14. A pair of vehicle footpegs, comprising:
a left vehicle footpeg and a right vehicle footpeg, wherein
said left vehicle footpeg comprises a left base portion that is attachable to a left side of a vehicle and a left foot support portion that is removably attached to said left base portion, said left foot support portion defining a serrated foot support surface to support said foot of a rider of said vehicle;
said right vehicle footpeg comprises a right base portion that is attachable to a right side of a vehicle and a right foot support portion that is removably attached to said right base portion, said right foot support portion defining a serrated foot support surface to support said foot of a rider of said vehicle.

15. The pair of vehicle footpegs of claim 14, wherein left foot support portion defines a height that is different from a height defined by said right foot support portion.

16. A method of providing customized footpegs, comprising:
providing a left vehicle footpeg and a right vehicle footpeg, wherein said left vehicle footpeg comprises a left base portion that is attachable to a left side of a vehicle and said right vehicle footpeg comprises a right base portion that is attachable to a right side of a vehicle;
permitting a user to select one of a plurality of available right foot support portions that are removably attachable to said right base portion and cooperate with the right base portion to define one of various heights of the right vehicle footpeg; and
permitting a user to select one of a plurality of available left foot support portions that are removably attachable to said left base portion and cooperate with the left base portion to define one of various heights of the left vehicle footpeg.
